(19) United States
(12) Patent Application Publication
(10) Pub. No.: US 2025/0245987 A1
(43) Pub. Date: Jul. 31, 2025

(54) METHOD AND SYSTEM FOR AI-ASSISTED RECORDING, REPLAY, AND REFEREE DECISION ANALYSIS IN SPORTING EVENTS

(71) Applicant: Tristan M. Yao, Davis, CA (US)

(72) Inventor: Tristan M. Yao, Davis, CA (US)

(21) Appl. No.: 19/185,153

(22) Filed: Apr. 21, 2025

Related U.S. Application Data
(60) Provisional application No. 63/636,502, filed on Apr. 19, 2024.

(51) Int. Cl. G06V 20/40; G06V 20/70

(52) U.S. Cl. CPC G06V 20/42; G06V 20/70

(57) ABSTRACT

A system for facilitating recording, replay, and analysis of sport actions is provided. The system includes a wearable video unit with a video capture mechanism and a communication subsystem. The video capture mechanism captures a video stream of a sport action and a corresponding referee call associated with the sport action. The system stores the video stream and the corresponding referee call. The system recognizes the referee call and annotates the video stream with the recognized referee call. The system also provides a replay of the video stream. The system further transmits the annotated video stream, which includes the referee call, to a storage device, thereby allowing the annotate video stream to be used as training data for an artificial intelligence (AI) engine to optimize an AI model for generating AI-based calls for sport actions.

### RELATED APPLICATION

This application claims the benefit of U.S. Provisional Application No. 63/636,502, Attorney Docket Number GBY 24-1001PSP, entitled “METHOD AND SYSTEM FOR FACILITATING INSTANT VIDEO REPLAY AND ANALYSIS FOR SPORTING EVENTS,” by inventors Tristan M. Y ao and Geoffrey B. Y ao, filed Apr. 19, 2024, the disclosure of which is incorporated herein.

### BACKGROUND

### Field

The present disclosure relates to artificial intelligence (AI). More specifically, the present disclosure relates to a system integrating wearable video recording devices, mobile computing platforms, and artificial intelligence (AI) to facilitate instant replay, referee decision augmentation, and training data collection for sports officiating.

### Related Art

Wearable video recording devices, such as smart glasses with video recording capabilities, are available on the market. However, these devices often lack integrated systems for real-time analysis, instant replay, and AI-based augmentation tailored for sports applications, particularly for refereeing decisions.

### SUMMARY

One aspect of the present disclosure provides a system for facilitating recording, replay, and analysis of sport actions. The system includes a wearable video unit comprising a video capture mechanism and a communication subsystem. During operation, the video capture mechanism captures a video stream of a sport action and a corresponding referee call associated with the sport action. The system also includes a mobile computing unit which is in communication with the communication subsystem, and which stores the video stream and the corresponding referee call. The mobile computing unit also recognizes the referee call and annotates the video stream with the recognized referee call. The system also includes a replay mechanism coupled to the mobile computing unit to provide a replay of the video stream in response to a replay command. The mobile computing unit also transmits the annotated video stream, which includes the referee call, to a storage device, thereby allowing the annotate video stream and the corresponding referee call to be used as training data for an artificial intelligence (AI) engine to optimize an AI model for generating AI-based calls for sport actions.

In a further aspect, the wearable video unit is a pair of glasses which comprises one or more video cameras.

In a further aspect, the mobile computing unit records the video stream in response to a voice command, which is captured by an audio input device.

In a further aspect, the system adjusts a playback speed based on a user input.

In a further aspect, the mobile computing unit receives the AI model to generate a referee call.

In a further aspect, the system provides the AI-generated referee call to a user wearing the wearable video unit.

In a further aspect, an artificial voice generator delivers the AI-generated referee call in a voice message.

In a further aspect, display mechanism displays the AI-generated referee call.

### BRIEF DESCRIPTION OF THE FIGURES

FIG. 1 illustrates an exemplary architecture and use case of the VRAIS system, in accordance with an aspect of the instant disclosure.

FIG. 2. illustrates an example of display of the VRAIS system, in accordance with one aspect of the present disclosure.

FIG. 3 presents a flow chart illustrating a process of recording video with the VRAIS system, in accordance with an aspect of the present disclosure.

FIG. 4 presents a flow chart illustrating a process of receiving and annotating a video stream, in accordance with an aspect of the present disclosure.

FIG. 5 presents a flow chart illustrating a process of generating an AI-assisted referee call during a sporting event, in accordance with one aspect of the present disclosure.

FIG. 6 presents an exemplary computing system that facilitates an AI-based language learning partner chatbot, in accordance with an aspect of the present disclosure.

In the figures, like reference numerals refer to the same figure elements.

### DETAILED DESCRIPTION

The following description is presented to enable any person skilled in the art to make and use the disclosed embodiments herein, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

Embodiments of the present disclosure provide a video replay, analysis, and interactive system (VRAIS) that can record live video of activities, provide instant replay, long-term storage, and AI-based augmentation. This system can provide a rich set of features for sports referees, coaches, athletes, and spectators. For certain sports which require a referee to make a call, such as fencing, the VRAIS system can use machine learning to train AI models and apply these models in real-time to assist the referee in making the correct calls.

In general, the VRAIS system can include a pair of glasses with video recording and processing capabilities, an optional mobile communication device such as a smartphone, and a cloud-based storage and processing system. The VRAIS system can also be based on a wearable recording device coupled with a processing module. In a typical scenario, during a sporting event, a referee can wear the VRAIS glasses, which can include one or more cameras. The VRAIS glasses can record the sporting event and send the video feed to a mobile device, such as a smartphone, which is also carried by the referee. The mobile device and store the video feed. When needed, the referee can use the mobile device for instant replay, so that a more accurate call can be made. The replay can be done on the mobile device, or through the VRAIS glasses if the glasses are equipped with display capabilities.

In addition, the VRAIS system can record, concurrently with the sporting event, the decisions and calls made by the referee, either based on recording of the referee's voice communication or by other forms of input of the referee's decision into the VRAIS system. These recorded referee decisions, together with the corresponding video stream, can be transmitted to and stored in a long-term, cloud-based storage system. The VRAIS system can then use these archived recordings and apply machine learning techniques to train an AI model, which after being trained can be used to predict referee calls during a live sporting event. Furthermore, the cloud-storage portion of the VRAIS system can serve as a repository of video records of a large collection of sporting events, which are recorded from a referee's point of view. These video records can then be retrieved later for training purposes.

### VRAIS System Architecture

The VRAIS system can be used for various sporting events, regardless of whether the event involves a referee. These sporting events can include but are not limited to: fencing, boxing, tennis, table tennis, badminton, wrestling, basketball, volleyball, soccer, American football, baseball, lacrosse, and ice hockey. Although the examples described herein are directed to the sport of fencing, the VRAIS system can be used in a wide range of sports and activities.

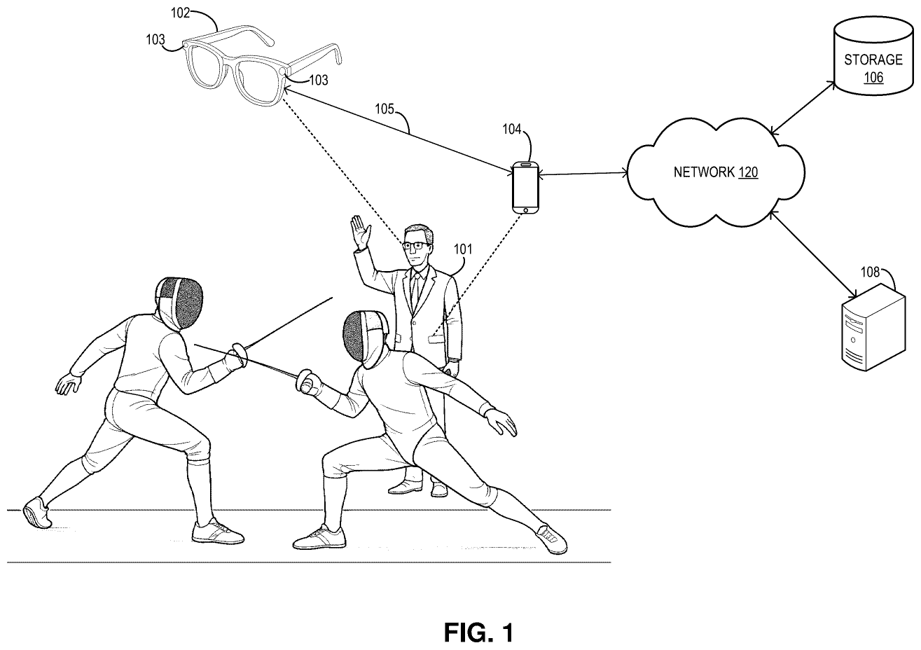

FIG. 1 illustrates an exemplary architecture and use case of the VRAIS system, in accordance with an aspect of the instant disclosure. In this example, the VRAIS system includes a pair of glasses 102, a smartphone 104, a cloud-based storage system 106, and an AI engine 108. A fencing referee 101 wears VRAIS glasses 102 and carries smartphone 104 during a fencing match.

In general, VRAIS glasses 102 can include one or more cameras 103, which can record a video stream during the fencing match. VRAIS glasses 102 can be in communication with smartphone 104 via a wireless communication link 105, which can be a Bluetooth link, a Wi-Fi link, or a link established over cellular networks. The video stream captured by VRAIS glasses 102 can be sent via wireless link 105 to smartphone 104, which can run a mobile application (referred to as “VRAIS app”) to receive, store, process, and re-transmit the video stream.

Smartphone 104 can perform several functions via the VRAIS app installed thereon. First, smartphone 104 can store the video recording provided by VRAIS glasses 102 and provide the stored video recording for replays. The replay can occur on smartphone 104, or optionally occur via VRAIS glasses 102 if VRAIS glasses 102 are equipped with a display mechanism. Such in-glass display mechanism can include but is not limited to: projection-based display, thin-film based display, microdisplay panels, MEMS laser beam scanners, and 2D reflective waveguide-based displays.

Smartphone 104 can also transfer the video recordings, over a network 120, to a long-term cloud-based storage system 106. Storage system 106 can serve a long-term, large-scale storage repository for a large quantity of video data, which can be made available for retrieval at a later time. There is a unique benefit in providing such a video recording repository, because the video recordings are taken from the perspective of a referee, which usually provides the best viewing angle for observing critical actions during the activity. Furthermore, the video repository can also serve as an archive on a semi-permanent or permanent basis.

In a further aspect, the video recordings stored in storage system 106 can be provided to AI engine 108. AI engine 108 can use machine learning techniques to train one or more AI models based on the recorded sports events, the recording of which can include the referee calls and the actions by the athletes. The AI models can be based on various flavors of neural networks, including deep learning models and convolutional neural networks. When sufficient pre-existing recordings with confirmed, correct referee calls are fed as training data into the AI model, the AI model can be trained to perform pattern recognition. Once an AI model is trained, AI engine 108 can load the AI model into the VRAIS app running on smartphone 104, which can then assist referee 101 in making calls in future events. More details on the VRAIS system being used as an augmented reality (AR) system to assist a referee in making calls are provided in subsequent sections of the present disclosure.

VRAIS glasses 102 can be worn by a referee during a sport competition. VRAIS glasses 102 can have one or more forward-facing cameras 103 that can record video of the activities being performed. The video stream can be stored either in VRAIS glasses 102 or on smartphone 104 carried by referee 101. In one aspect, VRAIS glasses 102 can have a camera lens placed in the center of the frame, facing forward. Alternatively, or additionally, VRAIS glasses can have two camera lenses 103 placed at the two corners of the frame. Lenses 103 can be wide-angle lenses for increased field of view. Other numbers of camera lenses (e.g., three or more) can also be used on VRAIS glasses 102. In a further aspect, the VRAIS recording device can also be a standalone device or camera that can be attached to a user's glasses or other part of the user's body or garment. This standalone device can include one or more camera lenses, which can be wide-angled.

In addition to cameras, VRAIS glasses 102 can include a set of communication functions, including, but not limited to, Wi-Fi, Bluetooth, and cellular. VRAIS glasses 102 can communicate with smartphone 104, as well as a remote server or cloud. In one aspect, the video stream captured by VRAIS glasses 102 can be transmitted via wireless communication link 105 to smartphone 104, which in turn can store the video stream locally. Smartphone 104 can also transmit the video stream to storage system 106, either in real time or at a later time when more bandwidth or processing power is available.

In one aspect, VRAIS glasses 102 can be controlled by user input or command. Referee 101 can control VRAIS glasses 102 via physical controls such as buttons placed on VRIAS glasses 102, via the VRAIS app running on smartphone 104, or via hand gestures which can be detected by the camera on VRAIS glasses 102. In addition, VRAIS glasses 102 can be equipped with a sound detection mechanism, such as a microphone, which can detect user's voice inputs. VRAIS glasses 102, optionally in conjunction with smartphone 104, can detect and recognize referee 101's voice input, convert the voice input into one or more commands, and use these commands to control VRAIS glasses 102. Furthermore, the recognized voice commands can be customized based on specific sport, which can be done via the VRAIS app.

In the sport of fencing, during a fencing bout, the fencers usually follow the instructions given by the referee. At the start of the action, the referee usually gives three instructions: “en garde,” “prets,” and “allez,” which are in French, or, correspondingly in English, “en garde,” “ready,” and “fence.” Upon hearing “en garde,” the fencers should be in the en garde position behind their respective en garde lines. Upon hearing “prets” or “ready,” the fencers should stop moving while maintaining their en garde positions. When the referee says “allez” or “fence,” the fencers start fencing.

When a touch is scored, the referee usually calls “halt” to stop the action, award a touch, instruct the fencers to return the en garde lines, and restart the fencing action for the next touch. In addition to a touch being scored, there are other events which can result in a “halt” instruction being issued. Such “halt” events include a fencer stepping out of the boundaries of the fencing strip, fencers causing body contact (“corp a corp”), and a fencer passing the opponent.

As mentioned earlier, the VRAIS system can be operated by voice command. For example, the VRAIS system's video recording function can be configured to start or stop the recording based on predetermined command, such as “start video” or “stop video.” The video recording functions can also be configured to start or stop based on sport-specific command such as “en garde,” “prets,” “ready,” “allez,” “fence,” and “halt.” Different commands in different languages can also be used. In addition, the video recording functions can be configured to stop later than the moment of the stop instruction, so that an extra amount of recording can be preserved after the stop instruction. In one aspect, the user (who can be a referee) can first select a sport and language (for example, “fencing” and “English”) from within the VRAIS app. During operation, the user can control the video recording by using the usual referee commands. For example, when VRAIS glasses 102 detects the voice command of “en garde,” the voice signal is passed on to smartphone 104 via wireless link 105. Smartphone 104 then recognizes this voice command, using a voice recognition engine, and maps it to a “start video recording” operation. Correspondingly, smartphone 104 issues an instruction via wireless link 105 to VRAIS glasses 102 to commence the video recording. In a further aspect, VRAIS glasses 102, optionally in conjunction with smartphone 104, can be configured to automatically start and stop video recording based on the movement or action detected by the camera. For instance, when the fencers are in an en garde position behind the en garde lines on the fencing strip and become substantially motionless, the VRAIS system can commence video recording. Similarly, when the VRAIS system detects a “halt” voice command, the system can stop the video recording. It is also possible for referee 101 to configure VRAIS glasses 103 to record continuously until a stop command is issued. In some aspects, VRAIS glasses 103 can record video at a frame rate of 30 fps or higher to provide sufficient quality in slow-motion replays.

When recording video, VRAIS glasses 102 can store the recorded video data on a local storage device (such as a micro SD card) and/or on smartphone 104 via the VRAIS app. The VRAIS app can be used to provide instant replay at regular or slower playback speed. The user can use a voice command or a touch screen on smartphone 104 to use the replay function on the VRAIS app. The user can also specify the replay speed, either via voice command or controls within the VRAIS app. For example, the referee can use the voice command “replay the last five seconds at half speed” to replay the previous five seconds of recorded video at 50% playback speed. VRAIS glasses 102 can be equipped with a display mechanism, in which case the us can use the voice command to initiate the replay function via the in-glass display. If VRAIS glasses 102 does not include a display mechanism, the replay can be displayed on smartphone 104. Note that it is possible for VRAIS glasses 102 to continue the video recording while replay is being provided either by the VRAIS app or the in-glass display.

In some aspects, smartphone 104 can be configured to provide live streaming of the video signal captured by VRAIS glasses 102 to a wide range of audiences. This unique feature allows multiple viewers to view the sporting event from the viewpoint of the referee. In one embodiment, the live streaming feature of the VRAIS system can be used for purposes of training a referee. For example, a junior referee can be wearing VRAIS glasses 102 while directing a fencing match. With the live streaming feature, a senior referee can be located nearby or at a remote location and still able to observe in real time the fencing match as well as the junior referee's officiating commands and calls, which are also part of the live streaming. Furthermore, the live streaming feature of the VRAIS system can be used to facilitate remote refereeing—where a referee can be located remotely to direct the fencing match. In this case, a user, who does not need to be a certified referee, can wear VRAIS glasses 102 and carry smartphone 104 which runs the VRAIS app. This user can turn on the live streaming feature of the VRAIS system, and send the live video stream to a remote referee. During a fencing match, the remote referee can issue commands to the user who is on site, and the user can relay these commands, instructions, and calls to the athletes. Furthermore, the remotely located referee can optionally have control of the VRAIS system worn by the user who is on-site. These remotely controlled functions can include start video recording, stop video recording, and replay at a specified speed. Note that the live streaming can be carried out continuously and independently from the video recording feature of the VRAIS system. That is, even when video recording is stopped, the live stream features can remain in operation.

In a further aspect, a referee user of the VRAIS system can request a more senior referee to review a call based on a replay. For example, in a fencing competition, an athlete is entitled to appeal a call. Such an appeal can occur when a question is raised on a questionable touch or on the annulment of a touch scored. The appeal is typically handled by the bout committee, which consists of one or more senior officials. Conventionally, where no video records are available, the appeal is processed based on verbal description of the actions in question. Although at high-level competitions conventional video replay might be offered, video replay is typically not available at lower-level competitions. In contrast, with the VRAIS system, these video replays are readily available to the bout committee whenever a questionable call is made or when an athlete appeals a call. In such cases, the referee whose call is challenged can submit or transmit the replay video clip, optionally at a slower-than-regular playback speed, to the bout committee or a senior reviewing referee, which can be located at the same venue or at a remote location. After reviewing the replay video clip, the bout committee or senior referee can determine the call, and send a message back to the referee on site with the determined call, such as “fencer on the right stepped off the strip before initiating the offensive action, no touch.” This video-based review can make the appeal process more objective and reliable. Note that, with this remote review feature, the working referee does not need to visit the bout committee or senior referee in person. In addition, the bout committee or senior referee can now be located remotely, which can help lower the costs of running the events.

### AI-Assisted Refereeing

As the costs of network bandwidth, computing resources, and storage capacity continue to decrease, the VRAIS system can also provide a cost effective AI-based augmentation to the referee's calls during a sporting event. Using fencing as an example, typically, a fencing bout halts when there is a touch scored or when a halt event occurs. The VRAIS system can feed live video data to an AI model, which can be included in the VRAIS glasses, a smartphone, or a remote compute node in the cloud or network. The live video feed can be the input data to the AI model, which can then predict a call when a halt event occurs. For example, when a fencer scores a touch resulting in a single light, the VRAIS glasses or the smartphone can indicate the fencer (e.g., the fencer on the left or on the right) who is to be awarded a point. When a fencer steps off the strip, the VRAIS glasses or the smartphone can also display a signal to indicate the halt call and indicate the content of the call (which in this case is “halt due to off strip”). Additionally, when a halt event occurs, in one embodiment, the VRAIS system can automatically replay the event, pause at the action that results in the call, and indicate what the call is corresponding to the action. For example, when a fencer steps off the strip, the VRAIS system can display a signal for the referee to call “halt,” replay the last five seconds of fencing, and pause the replay at the moment when a fencer steps off the strip.

The AI-assisted VRAIS system can also be used to predict calls for right-of-way weapons in fencing. Right of way is a rule used in foil and saber fencing to determine which fencer is awarded a point when both fencers hit each other at nearly the same time. It is not used in epee, where both fencers can score simultaneously. The concept is based on the idea of who had the attacking initiative and who properly followed the conventions of offense and defense. In foil and saber, the fencer who initiates a correct attack is said to have right of way. A correct attack is one that begins with a clear forward movement and extension of the arm, showing intent to hit. If the attack lands and is not blocked or interrupted by the opponent, the attacking fencer gets the point. If both fencers attack, the referee will judge who started first. If it is clear one fencer began before the other, that fencer is given priority. If both attacks appear to start at the same time and land at the same time, the action is considered simultaneous, and no point is awarded.

If a fencer successfully blocks their opponent's attack with a parry and then immediately responds with a counterattack known as a riposte, they take over right of way. In that case, if the riposte lands, that fencer is awarded the point because they defended successfully and responded correctly. On the other hand, if a fencer simply tries to hit back during the opponent's attack without making a parry or gaining priority, this is considered a counterattack. Even if the counterattack lands, the fencer who had right of way will be awarded the point, not the one who counterattacked.

Saber fencing follows the same right of way principles as foil, but the action is much faster and includes cuts with the edge of the blade in addition to thrusts. Referees consider timing, blade contact, and body position to determine who had the initiative.

In epee fencing, right of way does not apply. If both fencers hit within 1/25th of a second, both are awarded a point. This makes epee a more straightforward weapon in terms of scoring, as timing and strategy work differently without the need for interpreting right of way.

In some embodiments, the VRAIS system can be used to collect training data to train an AI engine for better prediction of the referee calls. As mentioned above, in fencing, different weapons have different rules. With foil and saber, whether a fencer can earn a point when there are double lights depends on whether this fencer has the right of way when delivering a touch. The right of way, depends on a number of factors, including whether the fencer has initiated and maintained an offensive action, or when the fencers has effectively defended against the opponent's offensive action. To make these right-of-way calls, the AI engine need to have sufficient training data to be able to make a call with high level of confidence. In addition, even with epee, which is a non-right-of-way weapon, certain calls would require the referee to have ability to tell the precise timing when a touch happens, such as off-strip touches, touches that happen when two fencers pass each other, or when two fencers' bodies collide (referred to as “corp a corp”). To have an AI engine to make these calls correctly, sufficient training data is also needed. The VRAIS system can be used to collect such training data because it retains the video recording of each action, and retains information of each call made by an actual referee. For example, when a touch is scored by the fencer on the right, the referee would say “Halt! Attack on the right to the left. Touch. Point to the right.” The VRAIS system can detect the referee's call using voice recognition, and retain this information in conjunction with the video recording of the corresponding action. The VRAIS system can then submit this recorded data (including both the video and referee's actual call which is synchronized to a period of time during which the action being called take place) to AI engine 108, which in turn can convert the voice recording of the call into text and interpret the text using natural language processing (NLP) or large language model (LLM). A large number of these video clips and referee-made calls can be stored and used by AI engine 108 to train its AI model coefficients to facilitate and improve future AI-generated calls.

In a further embodiment, the VRAIS system can retain all the recorded video data of a large number of competitions and store them in a database, with associated information such as competition name, data, bout order, athlete names, referee name(s), and bout time. The recorded data can then be accessed by users for reference or analysis.

During the AI-assisted augmented-reality (AR) operation of the VRAIS system, a pre-trained AI model (such as a deep learning neural network) with pre-determined coefficients can be loaded to the V RIA S app running on the mobile device carried by the referee, or be leaded to the VRAIS glasses if sufficient processing power if available in the glasses. The AI model can also be running on an AI engine located remotely and make calls based on the video feed provided by the VRAIS app. The AI-made calls can then be transmitted back to the VRAIS app or glasses to be displayed to the referee or user.

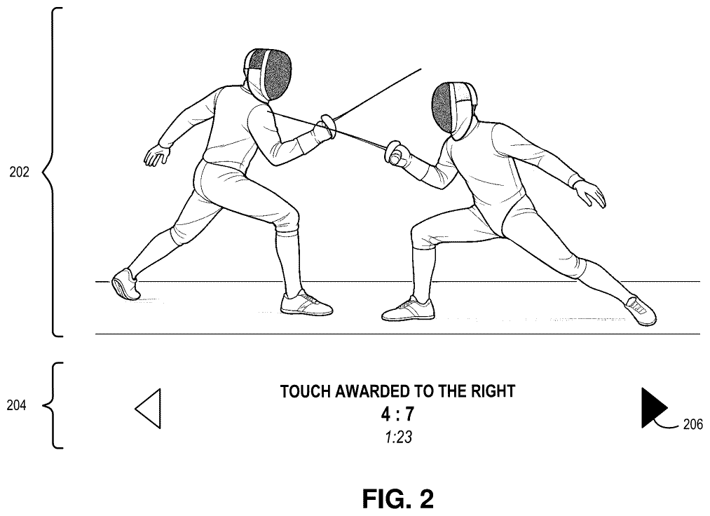

FIG. 2. illustrates an example of display of the VRAIS system, in accordance with one aspect of the present disclosure. Note that the example in FIG. 2 can be displayed via the VRAIS glasses or the VRAIS app. In this example, the display area can include a viewing area 202 and view area 204. Viewing 202 can display the fencers in action. If the display is provided by the VRAIS glasses, display 202 can be the view of the reality through the transparent lenses of the glasses. If the display is provided via the VRAIS app, display area 202 can be the video stream provided by the camera(s) of the VRIAS glasses. In one embodiment, after detection a fencing action that results in a call, the AI-assisted VRAIS system can display the call in display area 204. Here the display message is “Touch awarded to the right.” Furthermore, display area 204 can also include indicators (such as a triangle indicator 206) which can light up when one side scores a touch. The AI-generated call can also be delivered via an audio signal using a synthesized voice (i.e., an artificial voice can read the AI-generated call to the user wearing the glasses). Note that sometimes an AI-generated call can be incorrect and a referee can over-ride the AI-generated call. In this case, the referee-generated call is recorded and provided to the AI engine, which can in turn further tune the coefficients of the AI model to improve its performance.

In further embodiments, display area 204 can include the score and time of a fencing match. The score and time can be controlled by the referee via the VRIAS app. For example, the referee can manually increment or adjust the score, or manually start or stop the clock. The referee can also set the VRAIS app to automatically set the score and control the clock based on the AI-assisted calls or the referee's calls.

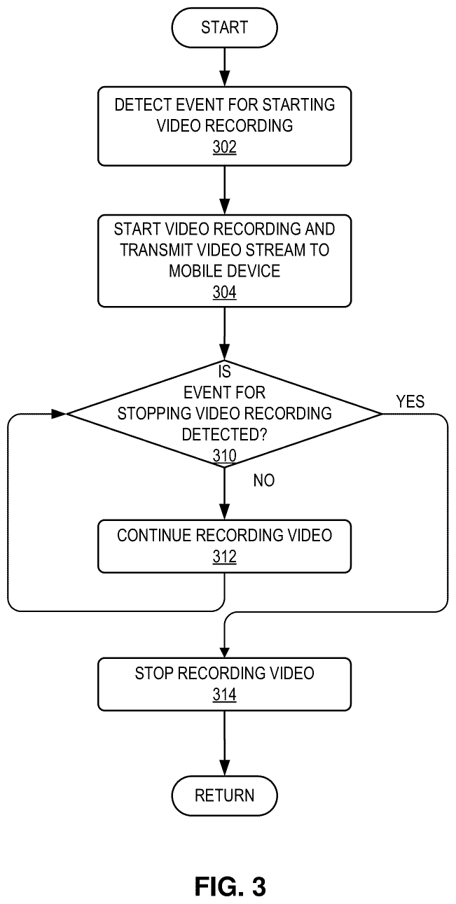

FIG. 3 presents a flow chart illustrating a process of recording video with the VRAIS system, in accordance with an aspect of the present disclosure. During operation, the VRAIS system can detect an event for starting the video recording (operation 302). This event can be a user input, which can be a manual input or voice input. Note that the user voice input for starting the video recording does not need to be a specific video-operation command, such as “start recording video.” The voice input can be a sport-specific referee command, such as “en garde” or “allez.” In other words, the event to trigger video recording can be a voice command that is directed to the sport, but not to the video recording mechanism. In a further embodiment, the event to trigger video recording can be a sports action such as when both fencers take the en garde position behind their respective en garde lines.

Subsequently, the VRAIS glasses can start recording video and transmit the video stream to the mobile device which runs the VRAIS app (operation 304). Note that this video recording can include both images and sound. In particular, this video recording can include any voice input from the user or referee wearing the VRAIS glasses.

The mobile device running the VRAIS app can then determine whether an event for stopping the video recording has been detected (operation 310). Such an event can include a voice command from the user or referee. This voice command can be a video operation-specific command, such as “stop video recording,” or a sport-specific referee command which is not directed to the video operation, such as a “halt” command for fencing. The event can also be an action taken by one or more athletes or players which can be recognized by the VRAIS system. For example, when the system detects that both fencers take off their masks, this event can trigger the stopping of the video recording. If no such event is detected, the system continues recording the video and monitor possible events (operation 312). If such an event is detected, the system can stop the video recording (operation 314).

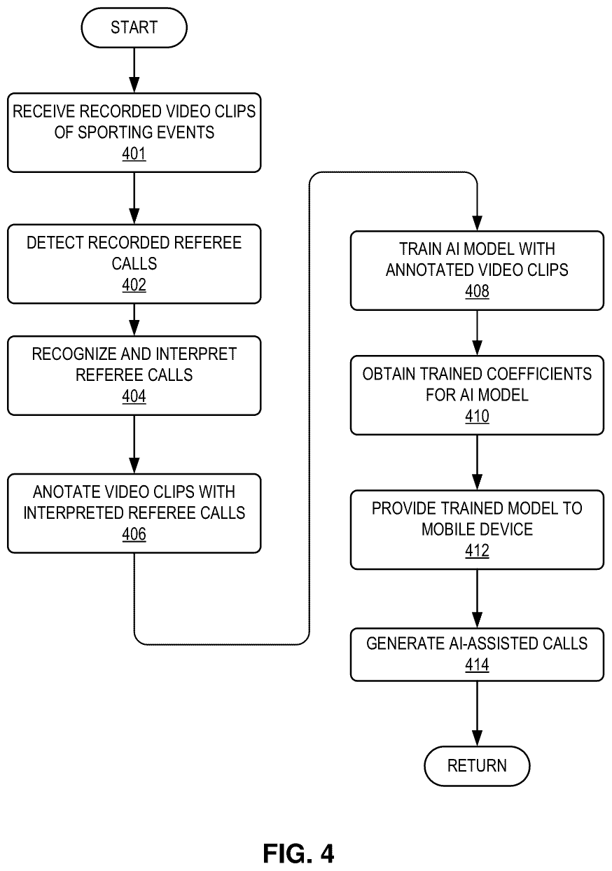

FIG. 4 presents a flow chart illustrating a process of receiving and annotating a video stream, in accordance with an aspect of the present disclosure. During operation, the VRAIS system can detect and interpret the referee calls in the video recording, and use this information to annotate the recording. The system first receives the recorded video clips or live video stream of sporting events from the VRAIS glasses (operation 401). Note that the video recording can be a previously recorded video clip, or a live video stream. The VRAIS system then detects one or more recorded referee calls (operation 402). Note that this detection can be performed by the VRAIS glasses or the VRAIS app. Furthermore, the referee call can be a voice instruction, such as “Halt! Attack by the left, parry and riposte by the right. Touch by the right. Point to the right.” The VRAIS system can detect such calls by detecting certain “trigger” words, which can be specific to each sport. In one embodiment, the user is allowed to configure such trigger words based on the sport of choice.

The VRAIS system subsequently can use a voice or pattern recognition system to recognize and interpret the detected referee call (operation 404). Once the referee call is recognized and analyzed, the system can annotate the video clips with the interpreted referee calls (operation 406). For example, at time t, the fencer on the right lands a touch on the fencer on the left, upon which the referee calls “Halt! Attack from the right. Touch. Point to the right.” In response, the VRAIS system recognizes and interprets this call, and creates a referee call record of “attack from right; touch; point to the right.” The VRAIS system can then annotate the frames in the video clip around time t (for example, n frames prior to and subsequent to time t) with the interpreted referee call. The system can perform this annotation to the entire video clip or stream.

After a large number of annotated video clips are collected, the VRAIS system can use these annotated video clips to train an AI model designed to recognize specific actions during the sporting event and generate similar referee calls (operation 408). After the training, the VRAIS system can obtain a set of converged coefficients for the AI model (such as coefficients for a deep learning neural network), which can be applied to a new video clip or stream (operation 410). The VRAIS system can then provided the trained AI model to the mobile device which is carried by the referee (operation 412). Using this AI model, the mobile device can then generate AI-assisted calls based on an incoming video stream (operation 414).

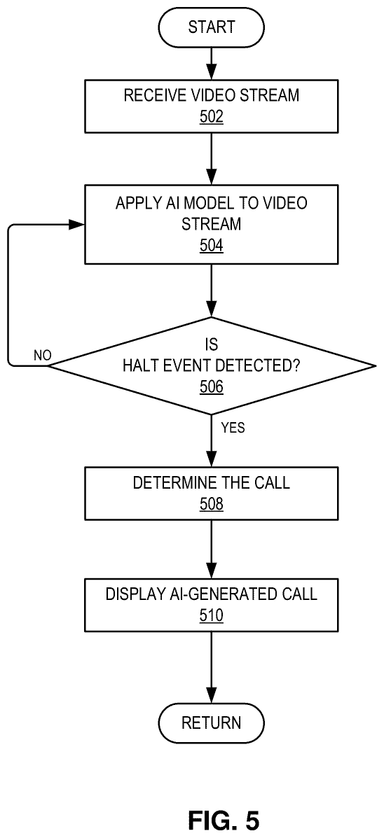

FIG. 5 presents a flow chart illustrating a process of generating an AI-assisted referee call during a sporting event, in accordance with one aspect of the present disclosure. During operation, the VRAIS system receives a video stream, which can be provided by a pair of VRAIS glasses (operation 502). The system can then apply the trained AI model to the received video stream (operation 504). Using the AI model in real time on the incoming video stream, the system can determine whether a callable event (such as a “halt” event in fencing) has been detected (operation 506). If no such event is detected, the system continues monitoring and applying the AI model to the incoming video stream (operation 504). If such an event is detected, the system can use the AI model to determine the call, which in the case of fencing can include the right of way and action leading to a touch (operation 508). The system can then display the AI-generated call, either via the VRAIS app or the VRIAS glasses (operation 510).

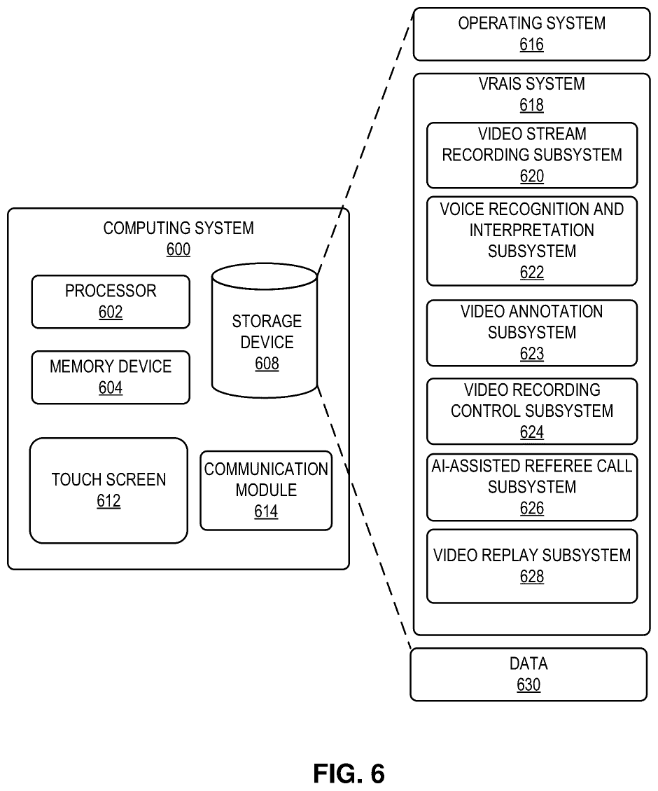

FIG. 6 presents an exemplary computing system that facilitates an AI-based language learning partner chatbot, in accordance with an aspect of the present disclosure. In this example, a computing system 600 can include a processor 802, a memory device 604, and a storage device 608. Computing system 600 can also include a touch screen 612 which can display information and receive user input via touches, and a communication module 614 which can receive and transmit video and audio content and messages.

Storage device 608 can store data 630 as well as computer-executable instructions which when executed by processor 602 can cause processor 602 to implement a number of functions and features. In particular, storage device 608 can store instructions that can implement an operations system 616 and a VRAIS system 618. VRAIS system 618 can include a video stream recording subsystem 620 which can store a video stream generated by the VRAIS glasses, either locally or remotely. VRAIS system 618 can further include a voice recognition and interpretation subsystem 622, which can recognize referee calls and commands. Also included is a video annotation subsystem 623, which can use the interpreted referee calls to annotate the recorded video stream. VRAIS system 618 can also include a video recording control subsystem 626, which can control the start and stop of the video recording based on recognized user commands. Further included is an AI-assisted referee call subsystem 626 which can use a trained AI model to generate a referee call during a live sporting event based on real-time video streaming. VRAIS system 628 can also include a video replay subsystem 628, which can provide video replay of a given instance, either locally or remotely over a network. This video replay mechanism can assist a remotely located referee in making a call even if the referee is not located on site at the sports venue.

The methods and processes described herein can be embodied as code and/or data, which can be stored in a non-transitory computer-readable storage medium. When a computer system reads and executes the code and/or data stored on the non-transitory computer-readable storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (A SIC) chip, a field-programmable gate array (FPGA), a dedicated or shared processor that executes a particular software module or a piece of code at a particular time, and/or other programmable logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A system for facilitating recording, replay, and analysis of sport actions, the system comprising:
a wearable video unit comprising a video capture mechanism and a communication subsystem, wherein the video capture mechanism is configured to capture a video stream of a sport action and a corresponding referee call associated with the sport action;
a mobile computing unit in communication with the communication subsystem and configured to store the video stream and the corresponding referee call, wherein the mobile computing unit is further configured to recognize the referee call and annotate the video stream with the recognized referee call; and
a replay mechanism coupled to the mobile computing unit and configured to provide a replay of the video stream in response to a replay command;
wherein the mobile computing unit is further configured to transmit the annotated video stream, which includes the referee call, to a storage device, thereby allowing the annotate video stream and the corresponding referee call to be used as training data for an artificial intelligence (AI) engine to optimize an AI model for generating AI-based calls for sport actions.

2. The system of claim 1, wherein the wearable video unit is a pair of glasses which comprises one or more video cameras.

3. The system of claim 1, wherein the mobile computing unit is further configured to record the video stream in response to a voice command; and
wherein the wearable video unit comprises an audio input device configured to capture the voice command.

4. The system of claim 1, wherein the replay mechanism is configured to adjust a playback speed based on a user input.

5. The system of claim 1, wherein the mobile computing unit is further configured to receive the AI model to generate a referee call.

6. The system of claim 5, further comprising a notification mechanism configured to provide the AI-generated referee call to a user wearing the wearable video unit.

7. The system of claim 6, wherein the notification mechanism comprises an artificial voice generator configured to deliver the AI-generated referee call in a voice message.

8. The system of claim 6, wherein the notification mechanism comprises a display mechanism configured to display the AI-generated referee call.

9. A method for facilitating recording, replay, and analysis of sport actions, the method comprising:
capturing a video stream of a sport action and a corresponding referee call associated with the sport action;
storing the video stream and the corresponding referee call on a mobile device;
recognizing the referee call;
annotating the video stream with the recognized referee call;
providing a replay of the video stream in response to a replay command; and
transmitting the annotated video stream, which includes the referee call, to a storage device, thereby allowing the annotate video stream and the corresponding referee call to be used as training data for an AI engine to optimize an AI model for generating AI-based calls for sport actions.

10. The method of claim 9, wherein the video stream is captured by a pair of glasses which comprises one or more video cameras.

11. The method of claim 9, further comprising:
capturing a voice command; and
recording the video stream in response to the voice command.

12. The method of claim 9, further comprising adjusting a playback speed based on a user input.

13. The method of claim 9, further comprising receiving the AI model to generate a referee call.

14. The method of claim 13, further comprising generating a referee call using the AI model on the video stream and providing the AI-generated referee call to a user.

15. The method of claim 14, wherein providing the AI-generated referee call to the user comprises delivering the AI-generated referee call in a voice message generated by an artificial voice generator.

16. The method of claim 14, wherein providing the AI-generated referee call to the user comprises displaying the AI-generated referee call.

17. A computer-readable storage medium storing instructions which when executed by a processor cause the processor to perform a method for facilitating recording, replay, and analysis of sport actions, the method comprising:
capturing a video stream of a sport action and a corresponding referee call associated with the sport action;
storing the video stream and the corresponding referee call on a mobile device;
recognizing the referee call;
annotating the video stream with the recognized referee call;
providing a replay of the video stream in response to a replay command; and
transmitting the annotated video stream, which includes the referee call, to a storage device, thereby allowing the annotate video stream and the corresponding referee call to be used as training data for an AI engine to optimize an AI model for generating AI-based calls for sport actions.

18. The computer-readable storage medium of claim 17, wherein the method further comprises capturing a voice command and recording the video stream in response to the voice command.

19. The computer-readable storage medium of claim 17, wherein the method further comprises receiving the AI model and generating a referee call using the AI model on the video stream.

20. The computer-readable storage medium of claim 19, wherein the method further comprises displaying the generated referee call to a user.
